(19) United States
(12) Patent Application Publication
(10) Pub. No.: US 2026/0281545 A1
(43) Pub. Date: Sep. 17, 2026

(54) VIDEO SHARING SYSTEM AND VIDEO SHARING METHOD

(71) Applicant: MAXELL, LTD., Kyoto (JP)

(72) Inventors: Yasunobu HASHIMOTO, Kyoto (JP); Mayumi NAKADE, Kyoto (JP)

(21) Appl. No.: 19/168,936

(22) PCT Filed: Mar. 29, 2023
(86) PCT No.: PCT/JP2023/012897

§ 371 Date: Sep. 25, 2025

(51) Int. Cl. H04N 23/661; G06T 7/70; H04N 23/698

(52) U.S. Cl. CPC H04N 23/661; G06T 7/70; H04N 23/698

(57) ABSTRACT

An image capturing terminal establishes an image capturing reference state, defining its position as an image-capturing-reference-point and its front direction as an image-capturing-reference-direction, acquires changes in its position and posture relative to this reference state, and transmits it as first correction information and captured video information to a display terminal. The display terminal sets a display reference state, defining its position as a display-reference-point and its front direction as a display-reference-direction, acquires changes in its position and posture relative to the display reference state as second correction information, and using the second correction information and the first correction information, corrects the captured video information to match a positional relation of an image capturing target object based on the image-capturing-reference-point-and-direction as to ensure an apparent positional relation of an image capturing target object video based on the display-reference-point-and-direction, and displays the corrected video information.

### TECHNICAL FIELD

The present invention relates to a video sharing system and a video sharing method.

### BACKGROUND ART

Patent Literature 1 discloses “a mount type device includes a camera configured to photograph a work site in a wider range than a visual field of a worker; a sensor configured to obtain a visual line of the worker as sensor information; and a visual line movement detector configured to detect, as visual line movement information, movement of a direction of the visual line of the worker by using the sensor information. The mount type device transmits data on the image photographed by the camera and the visual line movement information to an operation instructing apparatus via a network. An operation instructing apparatus includes a display setter configured to extract a first image having a wider range than a visual field range of the worker from the image photographed by the camera, correct the first image using the visual line movement information, and cause a display to display the corrected first image; and an instruction image generator configured to generate an instruction image for the worker, and transmits the instruction image to the mount type device via the network (excerpted from Abstract)”.

### CITATION LIST

### Patent Literature

Patent Literature 1: WO/2020/178960

### SUMMARY OF INVENTION

### Technical Problem

In the prior art, a large fixed display device is used in order for a work supporter to see a wide range of a work site without being affected by the motion of the direction of an image capturing terminal which is capturing a video of the work site. However, this may cause a problem that the size of the device becomes large.

The present invention has been made in view of the circumstances described above, and an object of the present invention is to provide a video sharing system and a video sharing method, which are capable of providing a video which is not affected by the motion of the direction of an image capturing terminal by linking the image capturing terminal operated by a person, who is capturing a video of a work state and the like, with a display terminal that receives and displays a captured video transmitted from the image capturing terminal, without using a fixed type large-scale display device.

### Solution to Problem

In order to solve the problem described above, the present invention includes the features described in the scope of claims. On of the aspects thereof is a video sharing system comprising an image capturing terminal and a display terminal which are connected with each other for communication therebetween, the image capturing terminal including: a camera; a first position and posture sensor configured to detect a position and a posture of the image capturing terminal; a first processor; and a first communication interface configured to transmit and receive data to and from the display terminal, the display terminal including: a display; a second position and posture sensor configured to detect a position and a posture of the display terminal; a second processor; and a second communication interface configured to transmit and receive data to and from the image capturing terminal, the first processor of the image capturing terminal being configured to: in an image capturing reference state set within a real space in which the image capturing terminal is present, set the position of the image capturing terminal as an image capturing reference point and set a direction toward which a front of the image capturing terminal is directed from the image capturing reference point as an image capturing reference direction; transmit the image capturing reference point and the image capturing reference direction to the display terminal; based on sensor information from the first position and posture sensor, acquire a change in the position of the image capturing terminal relative to the image capturing reference point and a posture change quantity of the image capturing terminal relative to the image capturing reference state when the camera captures a video of an image capturing target object; and transmit, to the display terminal, the change in the position of the image capturing terminal and the posture change quantity of the image capturing terminal as first correction information, together with captured video information generated by capturing the video of the image capturing target object using the camera, the second processor of the display terminal being configured to: in a display reference state set within a real space in which the display terminal is present, set the position of the display terminal as a display reference point and set a direction toward which a front of the display terminal is directed from the display reference point as a display reference direction; based on sensor information from the second position and posture sensor, acquire a change in the position of the display terminal relative to the display reference point and a posture change quantity of the display terminal relative to the display reference state as second correction information; correct the captured video information using the first correction information and the second correction information so as to match a positional relation of the image capturing target object based on the image capturing reference point and the image capturing reference direction with an apparent positional relation of the video of the image capturing target object based on the display reference point and the display reference direction; and display the captured video information thus corrected on the display.

### Advantageous Effects of Invention

According to the present invention, it is possible to provide a video sharing system and a video sharing method, which are capable of providing a video which is not affected by the motion of the direction of an image capturing terminal by linking the image capturing terminal operated by a person, who is capturing a video of a work state and the like, with a display terminal that receives and displays a captured video transmitted from the image capturing terminal, without using a fixed type large-scale display device. The objects, configurations, and advantageous effects other than those described above will be clarified by explanation of the embodiments below.

### BRIEF DESCRIPTION OF DRAWINGS

FIG. 1 is a schematic configuration diagram of a video sharing system according to the first embodiment.

FIG. 2 is a hardware configuration diagram of an image capturing terminal and a display terminal.

FIG. 3 is a hardware configuration diagram of a smartphone.

FIG. 4A is a functional block diagram of an image capturing terminal 1A in a video sharing system.

FIG. 4B is a functional block diagram of a display terminal 1B in a video sharing system.

FIG. 5A illustrates an example of a positional relation among an image capturing reference point, an image capturing reference direction, and an image capturing target object within an image capturing space in which an image capturing terminal is present.

FIG. 5B illustrates a video captured in the positional relation illustrated in FIG. 5A.

FIG. 6A illustrates an example of a positional relation among a display reference point, a display reference direction, and an image capturing target object video within a display space in which a display terminal is present.

FIG. 6B illustrates a display video in the positional relation illustrated in FIG. 6A.

FIG. 7A illustrates an example of a positional relation when a position and an orientation of an image capturing terminal have changed relative to the position and direction of the image capturing terminal illustrated in FIG. 5A.

FIG. 7B illustrates a captured video in the positional relation illustrated in FIG. 7A.

FIG. 7C illustrates a video on a display terminal when an image capturing terminal is in the state illustrated in FIG. 7A and a display terminal is in the state (reference state) illustrated in FIG. 6A.

FIG. 8A illustrates an example of a positional relation when a position and an orientation of a display terminal have changed relative to the position and the direction of the display terminal illustrated in FIG. 6A.

FIG. 8B illustrates a display video in the positional relation illustrated in FIG. 8A.

FIG. 9 illustrates parameters to be used in the explanation of a video correction method.

FIG. 10 illustrates a relative relation of a captured video and that of a display video relative to a reference video.

FIG. 11 is a diagram for explaining parameters to be used in a real space in which an image capturing terminal is present.

FIG. 12 is a diagram for explaining parameters to be used in a real space in which a display terminal is present.

FIG. 13 illustrates a flowchart of a processing flow of video sharing system processing according to the first embodiment.

FIG. 14 illustrates an example of a display video according to the second embodiment.

FIG. 15 illustrates a flowchart of a flow of processing according to the second embodiment.

### DESCRIPTION OF EMBODIMENTS

According to the present invention, improvement in the visibility of a captured video in which a worker who is working in a work site is captured can be expected when a supporter who supports the worker in a back-office sees the captured video. Thus, the present invention is expected to improve a technology for labor-intensive industries involving work support and back-office support, and therefore, can contribute to Goal 8.2 (Achieve higher levels of economic productivity through diversification, technological upgrading and innovation, including through a focus on high-value added and labor-intensive sectors) of the Sustainable Development Goals (SDGs) proposed by the United Nations.

Hereinafter, embodiments of the present invention will be described with reference to the drawings. In each of the drawings for explaining the embodiments, the same members are generally provided with the same reference signs, and repetitive explanation thereof will be omitted.

### First Embodiment

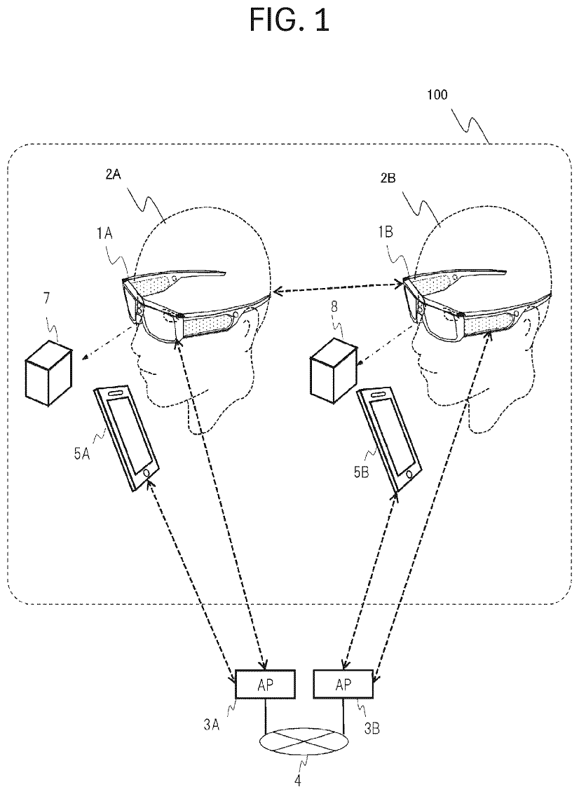

FIG. 1 is a schematic configuration diagram of a video sharing system according to the first embodiment. Video information about an image capturing target object 7 captured by an image capturing terminal 1A, which is a mobile information terminal worn by a user 2A, is transmitted to a display terminal 1B, which is a mobile information terminal of a user 2B. Together with the video information, information showing a relation between the video, and an image capturing reference point and an image capturing reference direction at the time of capturing the video is also transmitted. In the display terminal 1B, an image capturing target object video 8, which is obtained by correcting a positional relation as if the image capturing target object 7 was present at a position set within a space in which the display terminal 1B is present, is displayed. The image capturing terminal 1A and the display terminal 1B may communicate directly with each other, or through a communication network 4 via access points 3A, 3B.

In the present embodiment, HMDs (Head Mounted Displays) are used as the image capturing terminal 1A and the display terminal 1B, respectively.

The users 2A, 2B operate smartphones 5A, 5B, respectively. The smartphones 5A, 5B may be connected for communication to the access points 3A, 3B and the communication network 4.

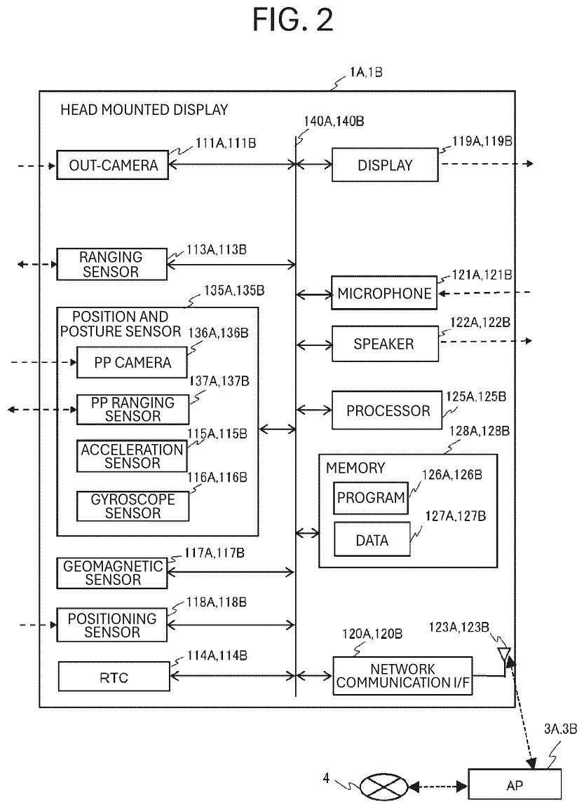

FIG. 2 is a hardware configuration diagram of an image capturing terminal and a display terminal. The image capturing terminal 1A and the display terminal 1B have the same configurations, and thus, in the following, the elements common in the image capturing terminal 1A and the display terminal 1B are provided with the same reference signs, however, also provided with the different alphabets A, B therewith for allowing them to be distinguished from each other.

The image capturing terminal 1A and the display terminal 1B include out-cameras 111A, 111B, ranging sensors 113A, 113B, position and posture sensors 135A, 135B, geomagnetic sensors 117A, 117B, positioning sensors 118A, 118B, RTCs (real-time clocks) 114A, 114B, displays 119A, 119B, microphones 121A, 121B, speakers 122A, 122B, processors 125A, 125B, memories 128A, 128B, and network communication I/Fs 120A, 120B, respectively, which are connected with each other via buses 140A, 140B. The network communication I/Fs 120A, 120B are connected to antennas 123A, 123B for transmitting and receiving network communication signals, respectively. The displays 119A, 119B and the speakers 122A, 122B correspond to output devices, respectively, and the microphones 121A, 121B correspond to input devices, respectively.

The position and posture sensors 135A, 135B are used to measure the positions and postures of the image capturing terminal 1A and the display terminal 1B, respectively. The term “posture” herein refers to three-dimensional rotation positions of the image capturing terminal 1A and the display terminal 1B within the real space in which they are present, respectively, which will be described in detail later. Specifically, the position and posture sensors 135A, 135B may be configured with position and posture cameras 136A, 136B (Position AND Posture cameras (hereinafter, abbreviated as “PP cameras”), position and posture ranging sensors 137A, 137B (Position AND Posture ranging sensors (hereinafter, abbreviated as “PP ranging sensors”), acceleration sensors 115A, 115B, and gyroscope sensors 116A, 116B. The PP cameras 136A, 136B may be the same as the out cameras 111A, 111B. Furthermore, the PP ranging sensors 137A, 137B may be the same as the ranging sensors 113A, 113B.

For measuring the position and posture using the PP cameras 136A, 136B and the PP ranging sensors 137A, 137B, a plurality of feature points existing in the external field are used. For example, feature points of the image capturing target object 7, feature points of the inside of a room, or, if the measurement is carried out outdoors, feature points of a building may be used. In preparation, the relative positional relation among the feature points is measured based on the measurement of the directions and distances of the feature points. This preparation can be omitted if the coordinate values of the feature points in the coordinate system of the external field have been known. Then, the changes in the directions and the distances of the feature points as viewed from the image capturing terminal 1A and the display terminal 1B are measured to measure the changes in the positions and postures of the image capturing terminal 1A and the display terminal 1B. Only the PP cameras 136A, 136B may be used in the case of measuring the distance using the technique of a stereo camera. If the coordinate values of the feature points in the external coordinate system are known and the relation between the external coordinate system and the vertical direction is also known, the relative relation between the postures of the housings of the image capturing terminal 1A and the display terminal 1B and the vertical direction can be grasped based on the posture measurement using the PP cameras 136A, 136B and the PP ranging sensors 137A, 137B.

The measurement of the positions and postures using the acceleration sensors 115A, 115B and the gyro sensors 116A, 116B is carried out by integrating the acceleration and the angular acceleration. This allows the displacement from a reference position and a reference posture to be obtained. Alternatively, by measuring the gravitational acceleration vector using the acceleration sensors 115A, 115B, the relative relation between the postures of the housings of the image capturing terminal 1A and the display terminal 1B and the vertical direction can be grasped.

In the measurement of the positions and postures of the image capturing terminal 1A and the display terminal 1B, both the measurement values using the PP cameras 136A, 136B and the PP ranging sensors 137A, 137B and the measurement values using the acceleration sensors 115A, 115B and the gyro sensors 116A, 116B may be referred to, or measurement values by other types of sensors may be used.

The positioning sensors 218A, 218B are used to measure the positions of the image capturing terminal 1A and the display terminal 1B indoors and outdoors. They are used when searching a library video relating to the image capturing target object 7. Specifically, the positioning sensors 218A, 218B for indoor use are, for example, the ones using beacon signals and the ones using position indicator marks. An example of the positioning sensors 218A, 218B for outdoor use are GPS (Global Positioning System) receivers using signals from satellites.

The network communication I/Fs 120A, 120B are communication interfaces for wireless communication between at least the image capturing terminal 1A and the display terminal 1B, and the access points 3A, 3B by short-range wireless communication, wireless LAN, or base station communication. The network communication I/Fs 120A, 120B include communication processing circuitry for various predetermined communication interfaces, and are connected to the antennas 123A, 123B. Then, the network communication I/Fs 120A, 120B carry out transmission and reception of biometric information, image data, control signals, and the like. The short-range wireless communication may be carried out using, for example, Bluetooth (registered trademark), IrDA (Infrared Data Association, registered trademark), Zigbee (registered trademark), HomeRF (Home Radio Frequency, registered trademark), or a wireless LAN such as Wi-Fi (registered trademark). The base station communication may be carried out using, for example, long distance wireless communication such as an LTE (Long Term Evolution (registered trademark) system, an LTE-Advanced system, a mobile WiMAX (Worldwide Interoperability for Microwave Access, registered trademark) system, or a WiMAX2 system.

The displays 119A, 119B are arranged in front of both the eyes of the users 2A, 2B wearing the image capturing terminal 1A and the display terminal 1B, respectively. The processors 125A, 125B control the operations of the image capturing terminal 1A and the display terminal 1B, respectively. In particular, the processors 125A, 125B correct the videos based on the real space information which have been captured by the out-cameras 111A, 111B, or correct the captured videos received from the access points 3A, 3B, to display them on the displays 119A, 119B, respectively.

The processors 125A, 125B are configured with, for example, CPUs.

The memories 128A, 128B are configured with flash memories and nonvolatile memories. The memories 128A, 128B retain programs 126A, 126B such as OSs (Operating Systems) and operation control applications, and also retain data 127A, 127B to be used by the processors 125A, 125B.

The processors 125A, 125B load the programs 126A, 126B into the memories 128A, 128B and execute them, and read the data 127A, 127B as needed to use it in the execution of the programs 126A, 126B.

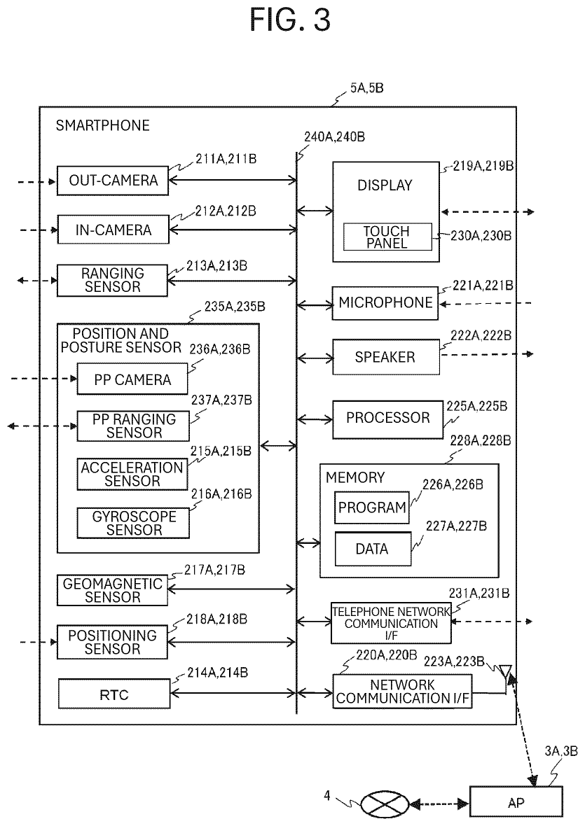

FIG. 3 is a hardware configuration diagram of a smartphone. The elements having the same names as those of the HMD have basically the same functions, and in the following, detailed explanations thereof will be omitted unless otherwise specified.

The smartphones 5A, 5B include out-cameras 211A, 211B, in-cameras 212A, 212B, ranging sensors 213A, 213B, position and posture sensors 235A, 235B, geomagnetic sensors 217A, 217B, positioning sensors 218A, 218B, RTCs 214A, 214B, displays 219A, 219B, microphones 221A, 221B, speakers 222A, 222B, processors 225A, 225B, memories 228A, 228B, telephone network communication I/Fs 231A, 231B, and network communication I/Fs 220A, 220B, respectively, which are connected to each other via buses 240A, 240B for connecting these elements. The network communication I/Fs 220A, 220B are connected to antennas 223A, 223B for transmitting and receiving network communication signals.

Specifically, in the same manner as the HMDs, the position and posture sensors 235A, 235B may be configured with PP cameras 236A, 236B, PP ranging sensors 237A, 237B, acceleration sensors 215A, 215B, and gyroscope sensors 216A, 216B. The PP cameras 236A, 236B may be the same as the out cameras 211A, 211B. Furthermore, the PP ranging sensors 237A, 237B may be the same as the ranging sensors 213A, 213B.

The memories 228A, 228B retain programs 226A, 226B and data 227A, 227B, respectively.

Touch panels 230A, 230B as input interfaces are laminated on the displays 219A, 219B, respectively.

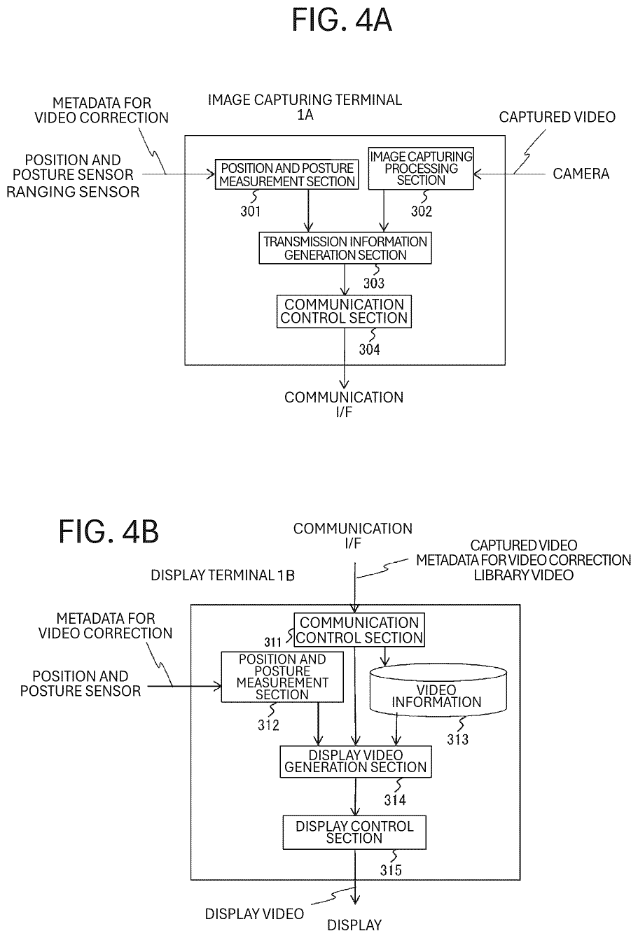

FIG. 4A is a functional block diagram of the image capturing terminal 1A in the video sharing system. FIG. 4B is a functional block diagram of the display terminal 1B in the video sharing system.

As illustrated in FIG. 4A, the image capturing terminal 1A includes a position and posture measurement section 301, an image capturing processing section 302, a transmission information generation section 303, and a communication control section 304. The position and posture measurement section 301 is configured to acquire sensor information from the position and posture sensor and the ranging sensor to generate first correction information to be transmitted to the display terminal 1B. The image capturing processing section 302 is configured to acquire captured video information from the camera to process the information. The transmission information generation section 303 is configured to transmit the first correction information and the captured video information. The communication control section 304 is configured to transmit and receive data to and from the display terminal 1B. The details of the first correction information will be described later.

As illustrated in FIG. 4B, the display terminal 1B includes a communication control section 311, a position and posture measurement section 312, a video information storage section 313, a display video generation section 314, and a display control section 315. The communication control section 311 is configured to transmit and receive data to and from the image capturing terminal 1A. The position and posture measurement section 312 is configured to acquire sensor information from a position and posture sensor mounted to the display terminal 1B to generate second correction information indicative of the change in the position and posture of the display terminal 1B. The video information storage section 313 is configured to retain the captured video information which has been received. The display video generation section 314 is configured to carry out the correction processing on the captured video using the first correction information and the second correction information. The display control section 315 is configured to carry out the display control on the display. The details of the second correction information will be described later.

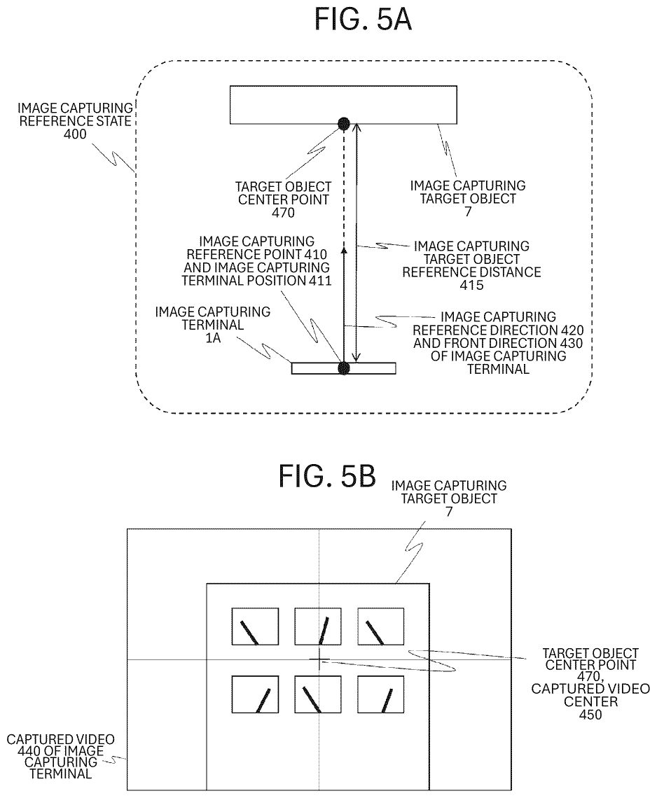

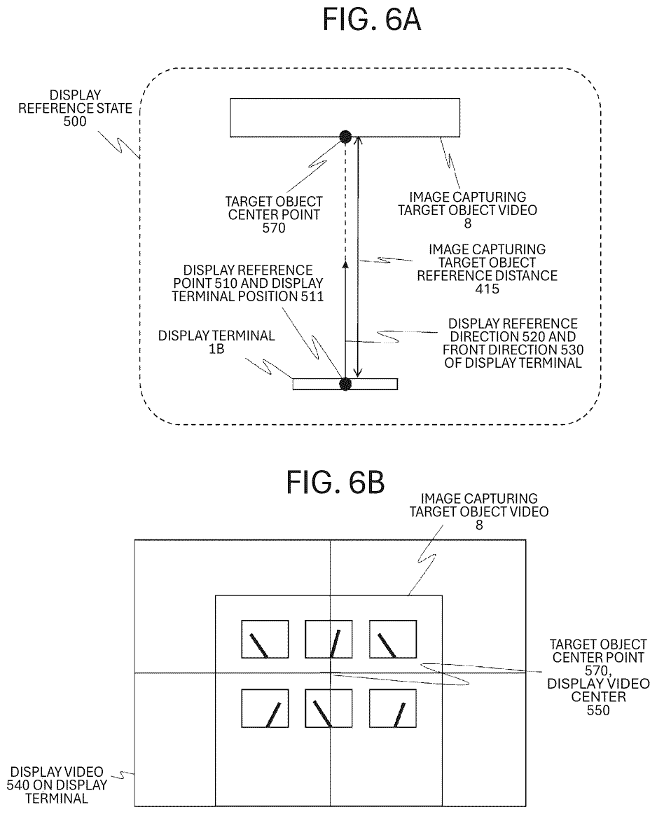

A video sharing system 100 according to the present embodiment includes a display mode for transmitting the video information, which has been generated by the image capturing terminal 1A by capturing a video of the image capturing target object 7, to the display terminal 1B to display it thereon, which is one of the advantageous aspects of the present invention. This advantageous feature will be described below based on FIG. 5A, FIG. 5B, FIG. 6A, and FIG. 6B. In the following, an example of a combination of HMDs, which are the image capturing terminal 1A and the display terminal 1B, will be explained, however, it may be a combination of smartphones 5A, 5B. Alternatively, it may be a combination of an HMD and a smartphone, or a combination of any type of mobile information terminals as long as they have the similar functions.

FIG. 5A illustrates an example of a positional relation among an image capturing reference point 410, an image capturing reference direction 420, and the image capturing target object 7 within an image capturing space in which the image capturing terminal 1A is present. The state in this positional relation will be referred to as an image capturing reference state 400. Furthermore, a point at which a straight line extending from the image capturing reference point 410 in the image capturing reference direction 420 comes into contact with the image capturing target object 7 is referred to as a target object center point 470.

In the image capturing reference state 400, for example, an image capturing terminal position 411 when the user 2A is in a position allowing him or her to work easily is set as the image capturing reference point 410. Furthermore, a direction in which a front direction 430, which is the optical axis direction of the out-camera 111A of the image capturing terminal 1A, is mainly directed during the work is set as the image capturing reference direction 420. As the work progresses, a position where the work is easy to be performed and a direction in which the front direction 430 of the image capturing terminal 1A is mainly directed may change. In such cases, the image capturing reference state 400 is updated in response to an instruction from the user 2A.

FIG. 5B illustrates a video captured in the image capturing reference state 400 illustrated in FIG. 5A. In the captured video illustrated in FIG. 5B, the image capturing terminal 1A and the image capturing target object 7 are in the positional relation illustrated in FIG. 5A, the image capturing terminal 1A is in the image capturing reference point 410, and the front direction 430 of the image capturing terminal 1A is directed to the image capturing reference direction 420. In this positional relation, the target object center point 470 on the image capturing target object 7 is positioned at a captured video center 450, which is the center of a captured video 440.

The distance between the image capturing reference point 410 and the target object center point 470 in the image capturing reference state 400 is defined as an image capturing target object reference distance 415. The image capturing target object reference distance 415 is measured by the ranging sensor 113A or the position and posture sensor 135A. The image capturing reference point 410 and the image capturing reference direction 420 are measured by the position and posture sensor 135A. The image capturing terminal 1A transmits the information about the image capturing reference point 410, the image capturing reference direction 420, and the image capturing target object reference distance 415 to the display terminal 1B at least every time the image capturing reference state 400 is set or updated.

FIG. 6A illustrates an example of a positional relation among a display reference point 510, a display reference direction 520, and an image capturing target object video 8 within a display space in which the display terminal 1B is present. The state in this positional relation will be referred to as a display reference state 500. When the image capturing target object 7 is in the positional relation (image capturing reference state 400) illustrated in FIG. 5A within the image capturing space, the positional relation of the image capturing target object video 8 within the display space in which the display terminal 1B is present becomes the one as illustrated in FIG. 6A. Here, the position of the image capturing target object video 8 refers to a position at which the user 2B feels that the image capturing target object video 8 is at that position within the display space, in other words, refers to a three-dimensional display position in a 3D video. That is, the captured video 440 is displayed on the display terminal 1B such that the position of the image capturing target object 7 based on the image capturing reference point 410 and the image capturing reference direction 420 and an apparent position of the image capturing target object video 8 based on the display reference point 510 and the display reference direction 520 become the same with each other. In other words, the display terminal 1B displays the image capturing target object video 8 as if it could be seen at the same position where the image capturing target object 7 is seen from the image capturing reference point 410 by the user 2B. The image capturing target object video 8 can be a more realistic video if the occlusion relation with other objects within the display space is expressed therein. The expression “image capturing target object video 8” without any special annotation refers herein to a video that can be seen by the user 2B as if it was located within the display space as described above.

In the display reference state 500, for example, a display terminal position 511 when the user 2B is in a position allowing him or her to see a display video easily is set as the display reference point 510. Furthermore, a direction in which a front direction 530 of the display terminal 1B is mainly directed while the user 2B is seeing the video is set as the display reference direction 520. However, as a standard setting, an elevation angle of the display reference direction 520 relative to the horizontal plane is adjusted to match an elevation angle of the image capturing reference direction 420. This allows the user 2B to see the state of the capturing site being captured with the same feeling as that of the user 2A. Here, the front direction 530 of the display terminal 1B refers to a direction extending in a direction perpendicular to the center of a display surface of the display 119B of the display terminal 1B or the center of a surface on which the user 2B recognizes that the video is being displayed. The center of a display surface may be appropriately defined if the center of a display area is not an obviously definable shape such as a rectangle. There may be cases where, during video sharing, the user 2B wishes to change a position at which the video is to be seen or a direction in which the front direction 530 of the display terminal 1B is to be mainly directed. In such cases, the image capturing reference state 400 can be updated in response to an instruction from the user 2B.

FIG. 6B illustrates a display video in the display reference state 500 illustrated in FIG. 6A. A display video 540 of the display terminal 1B becomes the one as illustrated in FIG. 6B when the image capturing target object video 8 is in the positional relation illustrated in FIG. 6A within the display space, the display terminal 1B is in the display reference point 510, and the front direction 530 of the display terminal 1B is directed to the display reference direction 520. In this positional relation, the target object center point 570 on the image capturing target object video 8 is positioned at a display video center 550, which is the center of the display video 540.

In the above, the example of the captured video 440 and that of the display video 540 when the image capturing terminal 1A and the display terminal 1B are in the reference positional relation. In the following, examples when they are in a general relation will be explained.

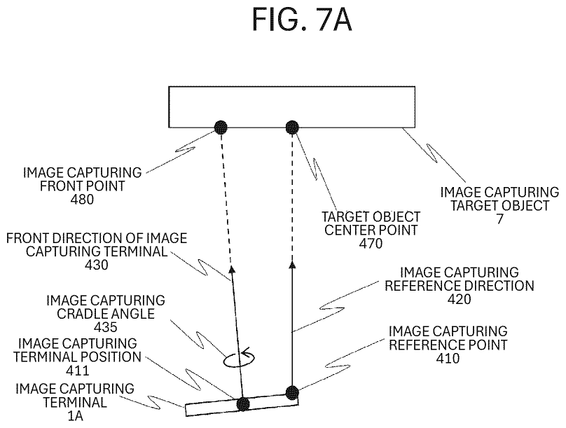

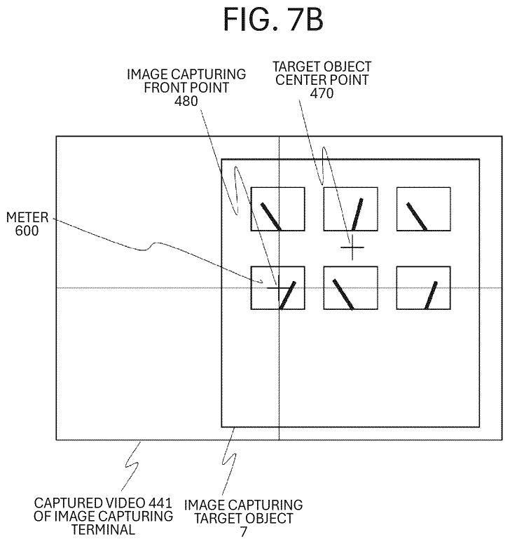

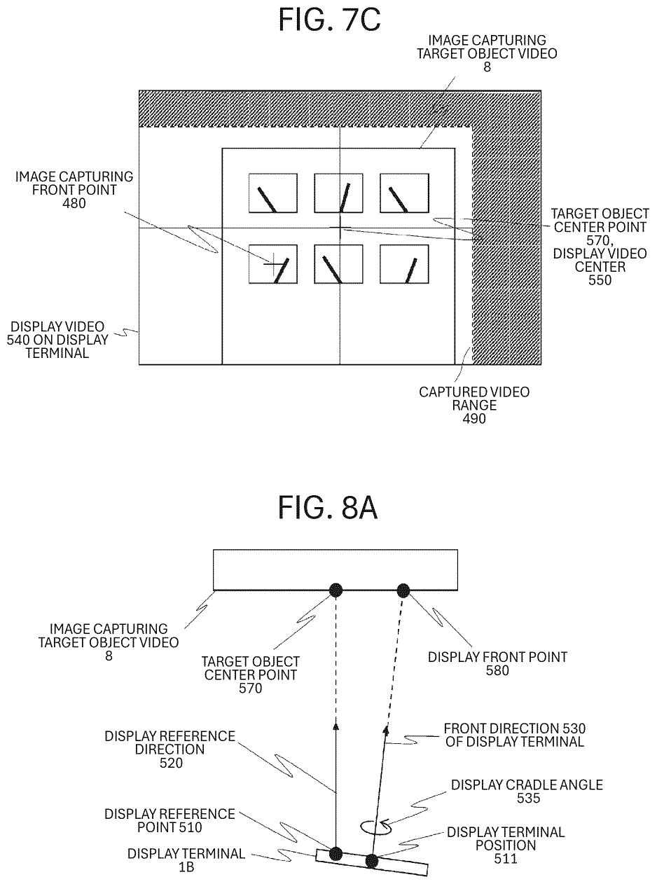

Firstly, referring to FIG. 7A and FIG. 7B, an example where the position and posture of the image capturing terminal 1A has changed will be described. FIG. 7A illustrates an example of a positional relation when the position and posture of the image capturing terminal 1A have changed relative to the position and posture of the image capturing terminal 1A illustrated in FIG. 5A.

In the following, the posture of a terminal will be described with reference to an example of the image capturing terminal 1A. In the present invention, a three-dimensional rotational position of a mobile information terminal within a real space is referred to as posture. In the case of the image capturing terminal 1A, the image capturing reference state 400 serves as the reference of the rotational position. The three-dimensional rotation quantity of the image capturing terminal 1A relative to the image capturing reference state 400 in the state where it is in a general state illustrated in FIG. 7A corresponds to the quantity of change in the posture of the image capturing terminal 1A. This three-dimensional rotation quantity is measured by the position and posture sensor 135A. In the following explanation, the three-dimensional rotation quantity is decomposed into the quantity of change relative to the image capturing reference direction 420 of the front direction 430 of the image capturing terminal and an image capturing cradle angle 435 which is the angle of rotation around the optical axis of the out-camera 111A relative to the image capturing reference state 400. Here, the optical axis direction of the out-camera 111A and the front direction 430 of the image capturing terminal 1A have been adjusted in the same direction.

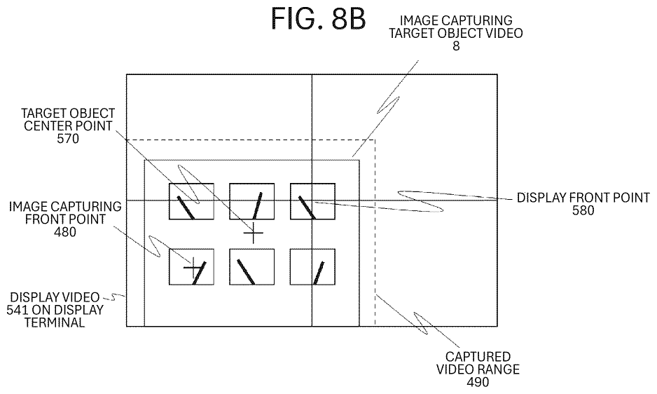

The same is applied to the display terminal 1B, and in the case of the display terminal 1B, the display reference state 500 serves as the reference of the rotational position. The three-dimensional rotation quantity relative to the display reference state 500 in the state where the display terminal 1B is in a general state illustrated in FIG. 8A corresponds to the quantity of change in the posture of the display terminal 1B. This three-dimensional rotation quantity is measured by the position and posture sensor 135B. In the following, the posture change quantity is decomposed into the quantity of change relative to the display reference direction 520 of the front direction 530 of the display terminal 1B and a display cradle angle 535 which is the angle of rotation around a vertical axis of the display surface of the display 119B relative to the display reference state 500. Here, the vertical axis direction of the display surface of the display 119B and the front direction 530 of the display terminal 1B have been adjusted in the same direction.

Both the position 411 of the image capturing terminal 1A and the front direction 430 thereof illustrated in FIG. 7A shift from the image capturing reference point 410 and the image capturing reference direction 420, respectively, which have been set in the image capturing reference state 400 illustrated in FIG. 5A. A point where a line obtained by extending the front direction 430 of the image capturing terminal 1A comes into contact with the image capturing target object 7 is referred to as an image capturing front point 480.

FIG. 7B illustrates a captured video 441 in the positional relation illustrated in FIG. 7A. In this case, the user 2A has moved his or her line of sight to check a meter 600 located at the lower left. In the captured video 441, the image capturing front point 480 is located at the center of the captured video 441, and the target object center point 470 is located at the upper right. Here, for correcting a display video 541 (see FIG. 8B), the position and posture sensor 135A is used to measure, as the correction information, the change in the position of the image capturing terminal position 411 relative to the image capturing reference point 410, the change in the front direction 430 of the image capturing terminal 1A relative to the image capturing reference direction 420, and the image capturing cradle angle 435, which is the angle of rotation around the optical axis of the out-camera 111A of the image capturing terminal 1A relative to the image capturing reference state.

Each of the change in the terminal position relative to the image capturing reference state 400, the change in the terminal front direction, and the cradle angle around the optical axis of the camera, which are measured by the image capturing terminal 1A, serves as one of the pieces of the correction information to be used for correction of the display video 541. Hereinafter, the change in the terminal position relative to the image capturing reference state 400, the change in the terminal front direction, and the cradle angle around the optical axis of the camera, which are measured by the image capturing terminal 1A, will be referred to as first correction information, respectively. In the case of the image capturing terminal, the change in the terminal front direction and the cradle angle around the optical axis of the camera are the specific contents of the change in the posture. On the other hand, as will be described later, the change in the terminal position relative to the display reference state 500, the change in the terminal front direction, and a cradle angle around a vertical axis of the display surface, which are measured by the display terminal 1B, are hereinafter referred to as second correction information, respectively. In the case of the display terminal, the change in the terminal front direction and the cradle angle around the vertical axis of the display surface are the specific contents of the change in the posture.

Then, the first correction information is transmitted to the display terminal 1B together with the captured video information. The terminal front direction 430 includes the information about the vertical direction. This enables adjustment of the lowering elevation angle as well.

FIG. 7C illustrates a video on the display terminal 1B when the image capturing terminal 1A is in the state illustrated in FIG. 7A and the display terminal 1B is in the state illustrated in FIG. 6A (display reference state 500). When the position of the image capturing terminal 1A which is illustrated in FIG. 5A changes to that illustrated in FIG. 7A, if the position of the display terminal 1B does not change, in the video on the display terminal 1B, a target object center point 570 is located at a display video center 550. That is, the captured video information is corrected so as to offset the change in the terminal position, the change in the terminal front direction, and the cradle angle around the optical axis of the camera, which are indicated as the first correction information, and the video thus corrected is displayed on the display terminal 1B.

Comparing FIG. 7C with FIG. 6B, in FIG. 7C, the image capturing target object video 8 transmitted from the image capturing terminal 1A is displayed only in a captured video range 490, and the area outside the captured video range 490 is a missing area where the video data is not to be displayed. The missing area is, for example, a black screen area. In FIG. 7C, the missing area is illustrated by diagonals.

FIG. 7C differs from FIG. 6B in that, in FIG. 7C, a screen including the missing area is displayed on the display 119B, while, in FIG. 6B, the whole area of the display 119B of the display terminal 1B corresponds to the captured video range 490 and thus a missing area does not appear on the display 119B. However, in the same manner as FIG. 6B, the target object center point 570 is located at the display video center 550 in FIG. 7C.

FIG. 8A illustrates an example of a positional relation when the position and posture of the display terminal 1B have changed relative to the position and posture of the display terminal 1B illustrated in FIG. 6A (display reference state 500). In the following, an example in which the position and posture of the display terminal 1B have changed to those illustrated in FIG. 8A will be described.

FIG. 8B illustrates a display video in the positional relation illustrated in FIG. 8A. Here, a display video center 550 is a point positioned at the center of the display video 541 on the image capturing target object video 8. Furthermore, the display video center 550 is the point where a line obtained by extending the front direction of the display terminal 1B comes into contact with the image capturing target object video 8, when the image capturing target object video 8 was positioned at a place within a space where the display terminal 1B is present which allows the user 2B to feel as if the image capturing target object video 8 was at that place. A sensor provided in the display terminal 1B and the position and posture sensor 135B are used to measure the change in the display terminal position 511 of the display terminal 1B relative to the display reference state 500, the change in the front direction 530 relative to the display reference direction 520, and a display cradle angle 535 around a vertical axis of the display surface relative to the horizontal state, each of which is one of the pieces of the second correction information.

The display terminal 1B performs, based on the second correction information and the first correction information transmitted from the capturing terminal 1A, position and magnification correction on the captured video information so that the displayed video 541 makes it as if the display terminal 1B is viewing the image capturing target object 7 from a corresponding position of the display terminal location 511 in the imaging space, as illustrated in FIG. 8B.

There may be cases where the captured video range 490 cannot cover the whole display area of the display 119B of the display terminal 1B in the case where the image capturing front point 480 and a display front point 580 are shifted from each other or due to correction of the magnification. In a modification for such cases, a wide-angle camera may be mounted to the image capturing terminal 1A to narrow a missing area.

Furthermore, the display terminal 1B may process the corrected video to appropriately enlarge or reduce in its size and display it.

In the drawings, the marks indicative of the target object center point, the image capturing center point, and the display center point are illustrated for convenience of explanation, and in actual cases as well, these marks may be displayed. Displaying the marks makes it easy to grasp the state of the video processing.

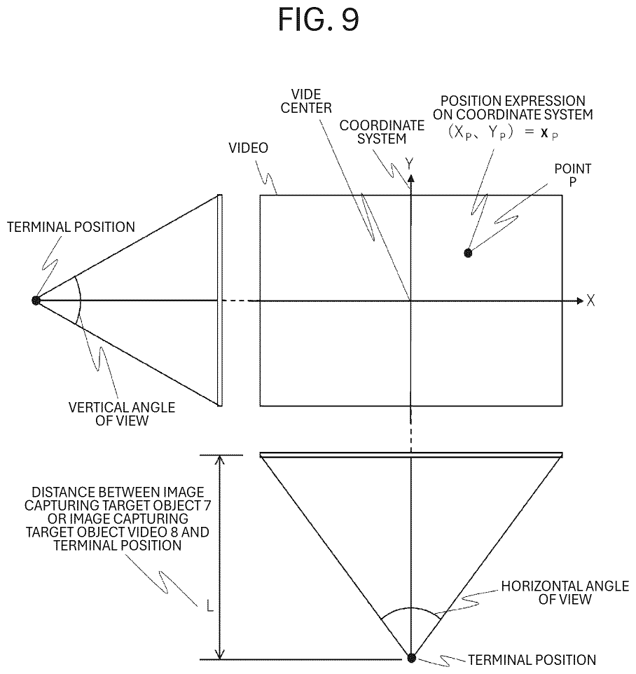

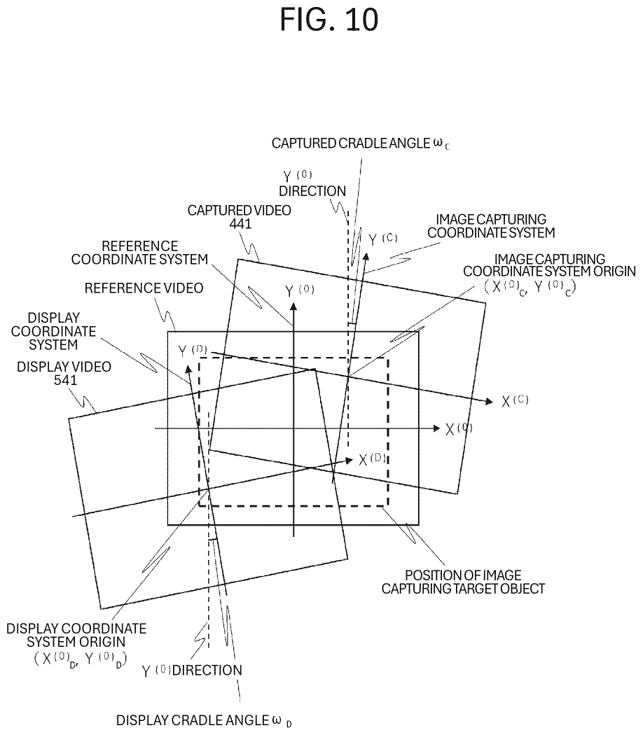

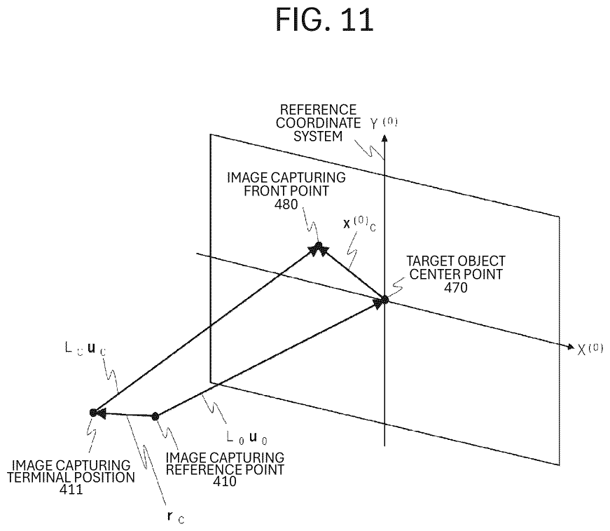

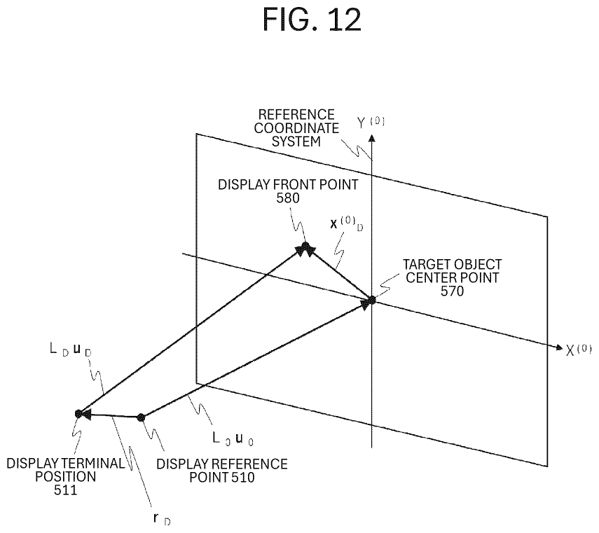

In the following, an example of the video correction method will be described with reference to FIG. 9 to FIG. 12. FIG. 9 illustrates parameters used in the explanation of the video correction method. FIG. 10 illustrates a relative relation of a captured video and that of a display video relative to a reference video. FIG. 11 is a diagram for explaining parameters to be used in a real space in which an image capturing terminal is present. FIG. 12 is a diagram for explaining parameters to be used in a real space in which a display terminal is present.

In the video sharing system and the video sharing method according to the present embodiment, correction of a video is carried out in the following two stages.

First correction: Setting back the change in the position of the image capturing target object in the video, which has caused by the change in the position or the posture of the image capturing terminal 1A.

Second correction: Reflecting the change in the position of the image capturing target object in the video, which has caused by the change in the position or the posture of the display terminal 1B.

In the present invention, it is presupposed that a reference video conceptually exists between a video captured by a camera, in other words, a captured video by the image capturing terminal 1A, and a display video to be displayed on the display 119B, in other words, to be displayed in the display terminal 1B. The reference video refers herein to a video obtained by capturing an object in the external field with the image capturing terminal 1A being in the image capturing reference state 400. That is, the reference video corresponds to the video illustrated in FIG. 5B.

In the following, reference states of terminals will be additionally described. In the image capturing reference state 400 of the image capturing terminal 1A and the display reference state 500 of the display terminal 1B, it is assumed that the terminals are in horizontal states, respectively. For setting a reference state of a terminal with the terminal being at any position and directed to any direction, a state in which the housing is brought into a horizontal state while the elevation angle being unchanged is used thereto. The state in which the housing is brought into the horizontal state refers to a state, for example, in the case of an HMD, where both the eyes of a user wearing the HMD are aligned in a horizontal direction, and in the case of a smartphone, the short side or the long side of the housing becomes horizontal. The typical image capturing range and the typical image display range are rectangular, and in such typical cases, the horizontal state refers to a state in which one side of the rectangle becomes horizontal.

After setting the reference states as described above, a terminal coordinate system is set for each video, with a video center as the origin, a video direction that becomes horizontal in the reference state as the X-axis, and the direction that is orthogonal to the X-axis as the Y-axis (FIG. 9). In the case of applying the definition above to a terminal having the video range which is not a rectangle, the video horizontal direction is set to a direction in the video which corresponds to the horizontal direction orthogonal to the terminal front direction in the external field in a state where the terminal is made in the horizontal state during its use.

The position of a point P in a video is expressed by coordinate values (X_{P}, Y_{P}). An angle allowing the full width of the video to be viewed from the terminal position of the image capturing terminal 1A serves as an angle of view. FIG. 9 illustrates a horizontal angle of view and a vertical angle of view. The angle of view may be different between the captured video and the display video. Here, the distance between the image capturing target object 7 or the image capturing target object video 8 and the terminal position is defined as L. In the reference video, L corresponds to the image capturing target object reference distance 415, which is the distance between the image capturing reference point 410 and the target object center point 470 and is also the distance between the display reference point 510 and the target object center point 570 (FIG. 5A and FIG. 6A). This is referred to as L₀ in FIG. 11. In the captured video, L corresponds to the distance between the image capturing terminal position 411 and the image capturing front point 480 (FIG. 7A). This is referred to as L_{C} in FIG. 11. In the display video, L corresponds to the distance between the display terminal position 511 and the display front point 580 (FIG. 8A). This is referred to as L_{D} in FIG. 12. When L differs from each other in these videos, the video range and the apparent size of the image capturing target object 7 differ from each other in them at the position of the image capturing target object 7 or the image capturing target object video 8, according to the ratio of L. Here, it is assumed that the apparent size changes in inverse proportion to L. The position of the image capturing target object video 8 refers herein to a position where the image capturing target object 7 captured by the image capturing terminal 1A is displayed on the display terminal 1B as if it were at that position.

In FIG. 10, the image capturing target object 7 is located at the common position in each video. However, depending on the position and posture of the image capturing terminal 1A, the captured video differs from the reference video. Here, the state in which the image capturing terminal 1A is positioned at the image capturing reference point 410, the front direction 430 of the image capturing terminal 1A is directed toward the image capturing reference direction 420, and the horizontal direction of the captured video corresponds to the horizontal direction of the real space is referred to as the image capturing reference state 400 (the state illustrated in FIG. 5A). When the position and orientation of the image capturing terminal 1A are displaced from those of the image capturing reference state 400, a point to be located at the center in the reference video is also displaced from the center in the captured video. Furthermore, when the image capturing terminal 1A is rotated around the optical axis of the camera and thus the posture of the image capturing terminal 1A is displaced from the direction of the image capturing reference state 400, the captured video is also tilted relative to the reference video.

In the same manner, depending on the position and posture of the display terminal 1B, the display video differs from the reference video. Here, the state in which the display terminal 1B is positioned at the display reference point 510, the front direction 530 of the display terminal 1B is directed toward the display reference direction 520, and the horizontal direction of the display video corresponds to the horizontal direction of the real space is referred to as the display reference state 500 (the state illustrated in FIG. 6A). When the position and orientation of the display terminal 1B are displaced from those of the display reference state 500, a point to be located at the center of the reference video is also displaced from the center in the display video. Furthermore, when the display terminal 1B is rotated around the vertical axis of the display surface and thus the horizontal direction of the video is displaced, the display video is also tilted relative to the reference video.

For explaining the relation between the position expressions in the videos, coordinate systems for the videos will be defined, respectively, as below. A reference coordinate system {X⁽⁰⁾, Y⁽⁰⁾} is used for the reference video, an image capturing coordinate system {X^{(C)}, Y^{(C)}} is used for the captured video, and a display coordinate system {X^{(D)}, Y^{(D)}} is used for the display video. The superscripts (0), (C) and (D) represent the coordinate systems, respectively. The image capturing coordinate system and the display coordinate system are the ones obtained by fixing the terminal coordinate system to the image capturing terminal 1A and the display terminal 1B in the reference states thereof, respectively, and they change following the change in the position and posture of the image capturing terminal 1A and those of the display terminal 1B. Hereinafter, these superscripts will be used to show which coordinate system is used for a certain position expression.

In the following, the relation between position expressions on coordinate systems is represented using a coordinate system origin position, a cradle angle of a coordinate system relative to the horizontal direction, and a distance L between an image capturing target object or a video of the image capturing target object, and a terminal position. An image capturing coordinate system origin position is represented by (X⁽⁰⁾_{C}, Y⁽⁰⁾_{C})=x⁽⁰⁾_{C}, and the image capturing coordinate system cradle angle is represented by ω_{C}. The cradle angle ω_{C} corresponds to the image capturing cradle angle 435 (FIG. 7A). Here, x⁽⁰⁾_{C} represents a vector of position coordinates, and the same is applied in the following. The display coordinate system origin position is represented by (X⁽⁰⁾_{D}, Y⁽⁰⁾_{D})=x⁽⁰⁾_{D}, and the display coordinate system cradle angle is represented by ω_{D}. The cradle angle ω_{D} corresponds to the display cradle angle 535. Here, for a cradle angle of a coordinate system, the counterclockwise direction relative to the reference coordinate system is defined as positive. The expression R(ω) is defined as a matrix representing the rotation with the cradle angle ω (counterclockwise direction is a positive direction). Hereinafter, a position expression represents a vector.

A point x⁽⁰⁾_{P} in a reference video to which a point x^{(D)}_{P} in a display video corresponds can be obtained by an equation (1) as below.

$${x}_{p}^{( 0 )} = ( {L}_{D} / {L}_{0} ) R ( {ω}_{D} ) {x}_{p}^{( D )} + {x}_{D}^{( 0 )} \qquad ( 1 )$$

Here, (L_{D}/L_{D}) represents the magnification of the apparent size which differs depending on the distance L.

Next, a point x^{(C)}_{P} in a captured video to which the point x⁽⁰⁾_{P} in the reference video corresponds can be obtained by an equation (2) as below.

$${x}_{p}^{( C )} = ( {L}_{0} / {L}_{C} ) R ( - {ω}_{C} ) ( {x}_{p}^{( 0 )} - {x}_{C}^{( 0 )} ) \qquad ( 2 )$$

Based on the above, the point x^{(C)}_{P} in the captured video to which the point x^{(D)}_{P} in the display video corresponds can be obtained by an equation (3) as below.

$${x}_{p}^{( C )} = ( {L}_{D} / {L}_{C} ) R ( - {ω}_{C} ) {x}_{p}^{( D )} + ( {L}_{0} / {L}_{C} ) R ( - {ω}_{C} ) ( {x}_{D}^{( 0 )} - {x}_{C}^{( 0 )} ) \qquad ( 3 )$$

Depending on the positional relation of the terminal, the corresponding point x^{(C)}_{P} may not be included within the field of view of the camera of the image capturing terminal 1A. In such a case, the image capturing terminal 1A acquires the image capturing reference direction, L₀, L_{C}, ω_{C}, and x⁽⁰⁾_{C}, which are the first correction information, and transmits the captured video information to the display terminal 1B together with the first correction information. The display terminal 1B acquires L_{D}, ω_{D}, and x⁽⁰⁾, which are the second correction information, and create a display video based on the second correction information in combination with the information transmitted from the image capturing terminal 1A.

Next, a method of measuring data for acquiring the first correction information will be summarized as below. The distance L₀ is measured by the ranging sensor 113A as the distance between the image capturing reference point 410 and the target object center point 470, when the image capturing terminal 1A is in the image capturing reference state 400 (FIG. 5A). The cradle angle ω_{C} is measured by the position and posture sensor 135A as the image capturing cradle angle 435 which is a cradle angle of the camera of the image capturing terminal 1A around the lens optical axis relative to the image capturing reference state 400, while the image capturing terminal 1A is capturing a video. The measurement of L_{C} and x⁽⁰⁾_{C} will be described below.

The distance L_{C} is obtained based on the front direction 430 of the image capturing terminal 1A. The distance L_{C} may be measured as the distance between the image capturing terminal position 411 and the image capturing front point 480, however, there is a possibility that an unexpected error may occur, for example, in the case where the image capturing front point 480 is positioned at a protruding portion of the image capturing target object 7. To avoid such an error, the origin of the image capturing coordinate system is set to a point where the plane, which includes the reference target object center point 470 and is perpendicular to the image capturing reference direction 420, and the front direction 430 of the image capturing terminal intersect. Then, the distance between the image capturing coordinate system origin set as described above and the image capturing terminal position 411 is defined as L_{C}. The point x⁽⁰⁾_{C} is also obtained as a coordinate value of this image capturing coordinate system origin in the reference coordinate system.

Next, a specific procedure of determining L_{C} and x⁽⁰⁾_{C} will be described (FIG. 7A, FIG. 11). Firstly, using the position and posture sensor 135A, a displacement r_{C} of the image capturing terminal position 411 relative to the image capturing reference point 410 at the time of capturing the video is measured. At the same time, the rotation of the front direction 430 of the image capturing terminal 1A relative to the image capturing reference direction 420 is measured to obtain a unit vector u_{C} of the front direction 430 of the image capturing terminal. Here, the unit vector of the image capturing reference direction 420 is defined as a u₀. Both L₀ and u₀ are measured in the state where the image capturing terminal 1A is in the image capturing reference state 400. FIG. 11 presupposes a three-dimensional coordinate system in which a two-dimensional reference coordinate system corresponds to the XY-plane. The reference coordinate system plane is perpendicular to the image capturing reference direction 420, and the X-axis direction of the reference coordinate system is set to the horizontal direction of the real space. The point x⁽⁰⁾_{C} is expressed by an equation (4) as below when it is interpreted as a vector of the three-dimensional coordinate system defined as above.

$${x}_{C}^{( 0 )} = {r}_{C} + {L}_{C} {u}_{C} - {L}_{0} {u}_{0} \qquad ( 4 )$$

The point x⁽⁰⁾_{C} is perpendicular to u₀, and thus an equation (5) as below is established.

$$( {r}_{C} + {L}_{C} {u}_{C} - {L}_{0} {u}_{0} ) \cdot {u}_{0} = 0 \qquad ( 5 )$$

Here, the symbol “·” represents an inner product.

Solving the equation (5), L_{C} is obtained by an equation (6) as below.

$${L}_{C} = ( {L}_{0} - {r}_{C} \cdot {u}_{0} ) / ( {u}_{C} \cdot {u}_{0} ) \qquad ( 6 )$$

Substituting the equation (6) into the equation (5), an equation (7) as below is obtained.

$${x}_{C}^{( 0 )} = {r}_{C} + \{ ( {L}_{0} - {r}_{C} \cdot {u}_{0} ) / ( {u}_{C} \cdot {u}_{0} ) \} {u}_{C} - {L}_{0} {u}_{0} \qquad ( 7 )$$

As described above, L_{C} and x⁽⁰⁾, can be calculated based on L₀, u₀, u_{C}, and r_{C}, and accordingly, the pieces of the first correction information to be measured by the image capturing terminal 1A and transmitted to the display terminal 1B are L₀, u₀, u_{C}, r_{C}, and ω_{C}.

Next, the second correction information L_{D} and x⁽⁰⁾_{D} to be obtained by the display terminal 1B will be described. The same as that described above can be applied to the display terminal 1B (FIG. 8A and FIG. 12). However, as the direction vectors u₀ and L₀ from the display reference point 510 to the target object center point 570, the ones which have been transmitted from the image capturing terminal 1A are to be used. Within a real space in which the display terminal 1B is present, a terminal position in the state where the display terminal 1B is in the terminal position and terminal posture of the display reference state 500 is set to the display reference point 510, and then a coordinate system is set such that a vector from the display reference point 510 toward the target object center point 570 becomes L₀u₀. In the case of the display terminal 1B, the target object center point 570 is a position where the target object center point 470 of the image capturing target object 7 is displayed as if it were at that position.

In the display terminal 1B, firstly, using the position and posture sensor 135B, a displacement r_{D} of the display terminal position relative to the display reference point 510 at the time of displaying the video is measured. At the same time, the rotation of the front direction 530 of the display terminal 1B relative to the display reference direction 520 is measured to obtain a unit vector Up of the front direction 530 of the display terminal 1B. In the following, applying the same as that for the image capturing terminal 1A, equations (8) and (9) below are obtained.

$${L}_{D} = ( {L}_{0} - {r}_{D} \cdot {u}_{0} ) / ( {u}_{D} \cdot {u}_{0} ) \qquad ( 8 )$$

$${x}_{D}^{( 0 )} = {r}_{D} + \{ ( {L}_{0} - {r}_{D} \cdot {u}_{0} ) / ( {u}_{D} \cdot {u}_{0} ) \} {u}_{D} - {L}_{0} {u}_{0} \qquad ( 9 )$$

As described above, the pieces of the second correction information to be measured by the display terminal 1B are u_{D}, r_{D}, and ω_{D}.

In the case where the front direction 430 of the image capturing terminal 1A is different from the image capturing reference direction 420, or in the case where the front direction 530 of the display terminal 1B is different from the display reference direction 520, trapezoidal distortion appears in the image. In this case, the video may be displayed after correcting the trapezoidal distortion. Furthermore, other approaches for correcting the distortion in the video may be used in combination with the one described above.

Still further, in order to synchronize the video information with the first correction information, a time stamp may be provided in the video information and the first correction information, respectively.

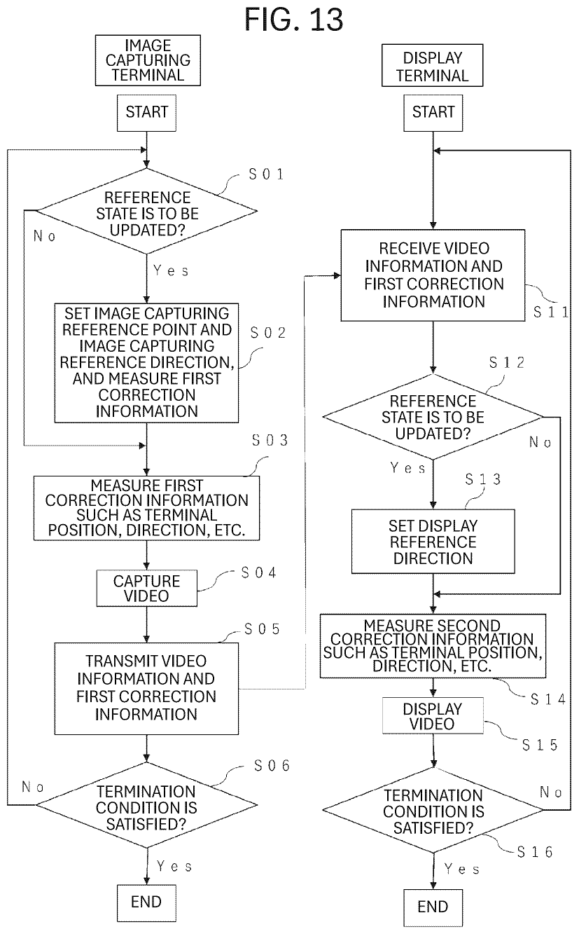

FIG. 13 illustrates a flowchart of a processing flow of the video sharing system according to the first embodiment.

Firstly, the user 2A wears and starts the image capturing terminal 1A. If the image capturing reference state 400 needs to be updated at the time of starting up and during sharing the video, YES is selected at the branching determination step S01 to make the flow proceed to S02. Otherwise, NO is selected to make the flow proceed to S03.

The processor 125A of the image capturing terminal 1A sets the image capturing reference point 410 and the image capturing reference direction 420 (u₀) in accordance with an input operation made by the user 2A. After this setting, with the image capturing terminal 1A being maintained in the image capturing reference state 400, the image capturing object reference distance 415 (L₀) is measured by the distance measuring sensor 113A and the image capturing reference direction 420 (u₀) is measured by the position and posture sensor 135A, respectively, as the first correction information (S02).

In the image capturing terminal 1A, using the position and posture sensor 135A, the displacement (r_{C}) of the image capturing terminal position 411 relative to the image capturing reference point 410, the front direction 430 (u_{C}) of the image capturing terminal, and the image capturing cradle angle 435 (ω_{C}) are measured as the correction information (S03).

The image capturing terminal 1A captures a video including the field of view of the user 2A, using the out-camera 111A (S04).

The image capturing terminal 1A transmits the video information and the first correction information to the display terminal 1B (S05). In the image capturing terminal 1A, until the termination condition is satisfied (S06: No), the flow returns to S01 and the processing is repeated. When the termination condition is satisfied (S06: Yes), the processing in the image capturing terminal 1A is terminated. The term “termination condition” refers herein to, for example, whether an operation of shutting down the image capturing terminal 1A or an operation of terminating the video sharing application has been performed.

Meanwhile, the user 2B wears and starts the display terminal 1B. The display terminal 1B receives the video information and the correction information from the image capturing terminal 1A (S11).

If the display reference state 500 needs to be updated at the time of starting up and during sharing the video, YES is selected at the branching determination step S12 to make the flow proceed to S13. Otherwise, NO is selected to make the flow proceed to S14.

The processor 125B of the display terminal 1B sets the display reference direction 520 in accordance with an input operation made by the user 2B (S13).

In the display terminal 1B, using the position and posture sensor 135B, the displacement (r_{D}) of the display terminal position 511 relative to the display reference point 510, the front direction 530 (u_{D}) of the display terminal, and the display cradle angle 535 (ω_{D}) are measured as the second correction information (S14).

The processor 125B of the display terminal 1B corrects the received video information using the first correction information measured by the image capturing terminal 1A and the terminal position of the display terminal 1B and the posture information about the display terminal 1B measured in step S13, and displays the video thus corrected on the display 119B (S15).

In the display terminal 1B, until the termination condition is satisfied (S16: No), the flow returns to S11 and the processing is repeated. When the termination condition is satisfied (S16: Yes), the processing of the display terminal 1B is terminated.

In the present embodiment, the image capturing terminal 1A sets the image capturing reference point 410 and the image capturing reference direction 420 based on the setting of the image capturing reference state 400 within the image capturing space in which the image capturing terminal 1A is present. The display terminal 1B sets the display reference point 510 and the display reference direction 520 based on the setting of the display reference state 500 within the display space in which the display terminal 1B is present. Then, the display terminal 1B displays the captured video 440 such that the position of the image capturing target object 7 based on the image capturing reference point 410 and the image capturing reference direction 420 and the apparent position of the image capturing target object video 8 based on the display reference point 510 and the display reference direction 520 become the same with each other.

Thus, even if the display terminal 1B to be used is a small-scale mobile terminal, the user 2B (for example, a person who supports the work) of the display terminal 1B can see the video of the direction in which he or she wishes to see near the direction in which the user 2A (for example, an operator) is seeing, by performing a natural operation of directing the display terminal 1B in that direction, without being influenced by the motion of the image capturing terminal 1A.

In the following, a possible modification example of the first embodiment will be described.

### (Adjustment of Display Reference State 500)

The basic concept of setting the display reference state 500 is to allow the user 2B to see the same video as that in the image capturing reference state 400 when moving to a position and taking a posture in which he or she can easily work. By changing the orientation of the display terminal 1B in that state, the user 2B can flexibly see a portion that he or she wishes to see. However, in some cases, the user 2B may wish to see the image capturing target object video 8 from a location that is largely away from the same video as that in the image capturing reference state 400 or from an angle which is different therefrom. For these cases, the display terminal position 511 and the front direction 530 of the display terminal may be displaced from the display reference state 500 when the user 2B moves a position and takes a posture in which he or she can easily work. That is, during sharing a video, the relative relations between the display terminal position 511 and the front direction 530 of the display terminal, and the display reference point 510 and the display reference direction 520 of the display reference state 500, respectively, may be appropriately changed or restored to the original state in response to an instruction from the user 2B. The same can be applied to displacement of the reference of the display cradle angle 535 relative to the horizontal direction.

This enables the user 2B of the display terminal 1B to see a video more flexibly.

### (Image Capturing Reference State)

In the first embodiment, for example, the image capturing reference state 400 is updated in response to an instruction from the user 2A depending on the progression of the work. In this case, for making the change in the display video caused by the change in the image capturing reference point 410 or that in the image capturing reference direction 420 smooth, it may be configured to carry out the change in the image capturing reference point 410 or that in the image capturing reference direction 420 continuously or gradually.

In a further modified example, the image capturing reference state 400 may be set based on an average position and an average posture of the image capturing terminal 1A. That is, an average position of the image capturing terminal position 411 may be set as the image capturing reference point 410, and an average direction of the front direction 430 of the image capturing terminal may be set as the image capturing reference direction 420.

This enables improvement in the visibility when the user 2B of the display terminal 1B sees a display video.

### (Processing Load Distribution)

Throughout the processing, a part of the processing may be executed by terminals which are paired with the image capturing terminal 1A and the display terminal 1B, such as smartphones 5A, 5B, respectively, or a server, so as to distribute the processing load on the image capturing terminal 1A and the display terminal 1B.

### (Selfie Mode)

For example, in the case of using the image capturing terminal 1A, such as a smartphone, which is capable of capturing a video of the user 2A himself or herself, the image capturing object 7 may be the user 2A. In the same manner as described above, a video that is not affected by the motion of the terminal can be provided in this case. In a selfie mode, the in-camera 212A is used in place of the out-camera 111A but basically the same processing as described above can be applied.

### (Mutual Mode)

One single mobile information terminal may be configured to execute both the processing of the image capturing terminal 1A and that of the display terminal 1B, so that both the image capturing terminal 1A and the display terminal 1B thus configured can mutually display the captured videos. In this mutual mode, each of the users can talk while seeing the surroundings and the like that his or her conversation partner is seeing, which enables enhancement in the level of communication. Combining the mutual mode with the selfie mode also enables, for example, communication in the manner of video telephone.

### Second Embodiment

The present embodiment relates to a substitute video of an area that cannot be captured by an image capturing terminal.

A captured video is recorded in the display terminal 1B or a server (not illustrated) so that, when a missing area appears in the display video being displayed, the video of the missing area is extracted from among previously captured videos and the previous video as extracted is fit and displayed onto the video being displayed. This is particularly advantageous if the previously captured video involves information that can be currently referred to as well. For example, information which does not change, for example, text for explaining an image capturing target object, is useful even if it is the one included in a previously captured video.

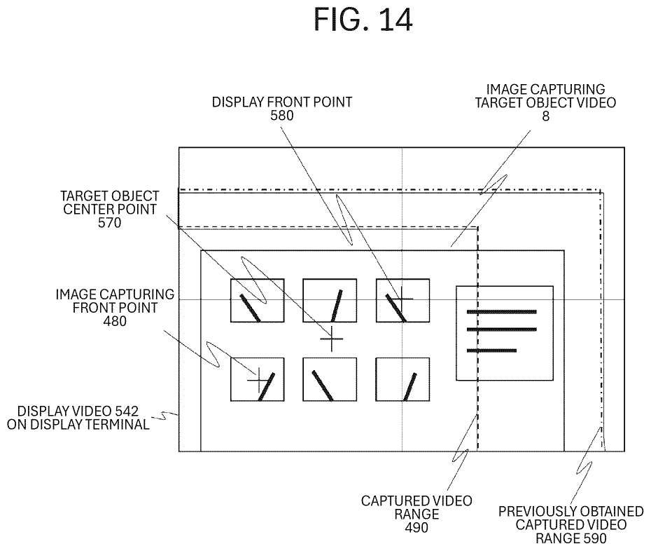

FIG. 14 illustrates an example of a display video according to the second embodiment.

As illustrated in FIG. 14, in the case where the captured video range 490 does not cover the whole display area of the display 119B of the display terminal 1B, the processor 125B of the display terminal 1B extrapolates a previously captured video range 590 to the captured video range 490 and displays it. The video information to be extrapolated may be the one obtained by capturing whole of the image capturing space in advance using the image capturing terminal 1A, or data about the image capturing space stored in a server (not illustrated) may be used for the video information.

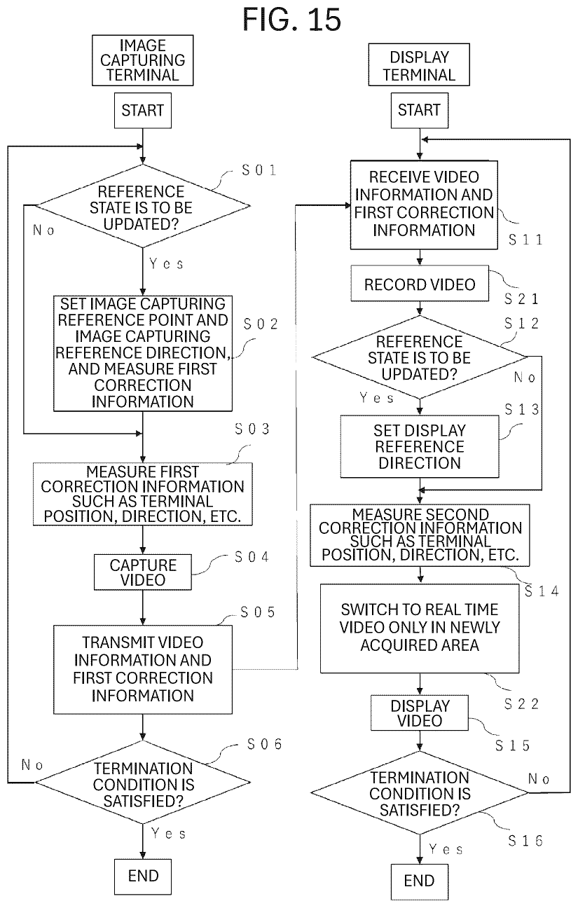

FIG. 15 illustrates a flowchart of a flow of the processing according to the second embodiment. In FIG. 15, the same steps as those in the flowchart illustrated in FIG. 13 are provided with the same step numbers, and repetitive explanation therefor is omitted herein.

The processes to be executed in the image capturing terminal 1A are the same as those according to the first embodiment.

Upon receiving the video information and the first correction information (S11), the display terminal 1B records the video (S21).

After measuring the second correction information about the display terminal 1B (S14), for the video information acquired in S11, the display terminal 1B switches only a video of a captured video area which is newly acquired to a real-time video (S22), and the video thus processed is displayed (S15).

That is, upon receiving the video information and the correction information in step S11 for the first time, the display terminal 1B displays the video of the captured video area 490 included in the received video information as a display video 542. Then, upon receiving new video information in step S12 in the second and subsequent loop processing, the display terminal 1B replaces the previously captured video range 590 with the captured video range 490 included in the new video information if the newly acquired captured video range overlaps with the previously captured video range 590 that has been extrapolated.

According to the present embodiment, in the case where a portion at which the user 2A is looking largely shifts from a portion at which the user 2B is looking and thus a non-display area stands out on the display terminal 1B, a previously captured video area is extrapolated onto a video to be displayed to the user 2B so that it can be displayed in a wider range than the newly received captured video area 490. Thus, by linking an image capturing terminal operated by a person, who is capturing a video of a work state and the like, with a display terminal that receives and displays a captured video transmitted from the image capturing terminal, a video with a wider display range to be provided to a display terminal without using a fixed type large-scale display.

In a further modified example, for the case where a plurality of image capturing terminals is used, a plurality of captured videos may be combined and displayed on a display terminal.

According to the present embodiment, firstly, the image capturing terminal 1A sets the image capturing reference point 410 and the image capturing reference direction 420 based on the setting of the image capturing reference state 400 within the image capturing space in which the image capturing terminal 1A is present. On the other hand, the display terminal 1B sets the display reference point 510 and the display reference direction 520 in the display reference state 500 within the display space in which the display terminal 1B is present. Then, the display terminal 1B displays the captured video 440 such that the position of the image capturing target object 7 based on the image capturing reference point 410 and the image capturing reference direction 420 and the apparent position of the image capturing target object video 8 based on the display reference point 510 and the display reference direction 520 become the same from each other. Furthermore, the previously captured video as recorded is also combined thereto and displayed. With this configuration, even if the display terminal 1B to be used is a small-scale mobile terminal, the user 2B of the display terminal 1B can see the video of the direction within a wide range, in which he or she wishes to see near the direction in which the user 2A of the image capturing terminal 1A is seeing, by performing a natural operation of directing the display terminal 1B in that direction, without being influenced by the motion of the image capturing terminal 1A.

In the above, the embodiments of the present invention have been described, however, it is apparent that the configurations for implementing the technical features according to the present invention are not limited to those described in these embodiments and various modifications can be made. For example, the embodiments described above have been explained in detail for the purpose of making the present invention to be understood easily, and thus are not necessarily limited to those having all the configurations as described. Furthermore, a part of the configuration of an embodiment may be replaced with the configuration of a further embodiment, and the configuration of an embodiment may include the configuration of a further embodiment, which are all included in the scope of the present invention. The numerical values and messages appearing in the text and drawings are merely examples, and accordingly, the advantageous effects of the present invention are not impaired even if different ones are used.

Furthermore, each of the programs described in the examples of the processing may be an independent program, or a plurality of programs may configure one application program. Still further, the orders of executing the processes may be changed.

Still further, some or all the functions and the like of the present invention may be implemented by hardware, for example, by designing them with integrated circuitry. Still further, a microprocessor unit, a CPU, or the like may interpret and execute an operation program so that some or all the functions and the like of the present invention can be implemented by software. Still further, the implementation range of the software is not limited, and hardware and software may be used in combination. Still further, some or all the functions may be realized by a server. Note that the server may be the one which executes the functions in cooperation with other components by communication, which may be, for example, a local server, a cloud server, an edge server, a net service, or the like. Information such as programs, tables, and files for realizing the functions may be stored in a recording device such as a memory, a hard disk, or an SSD (Solid State Drive), or a recording medium such as an IC card, an SD card, or a DVD, or may be stored in a device on a communication network.

Still further, the control lines and information lines which are considered to be necessary for the purpose of explanation are indicated herein, but not all the control lines and information lines of actual products are necessarily indicated. It may be considered that almost all the components are actually connected to each other.

The embodiments described above include the following aspects of the present invention.

### APPENDIX 1

A video sharing system comprising an image capturing terminal and a display terminal which are connected with each other for communication therebetween,
the image capturing terminal including:
   a camera;
   a first position and posture sensor configured to detect a position and a posture of the image capturing terminal;
   a first processor; and
   a first communication interface configured to transmit and receive data to and from the display terminal,
   the display terminal including:
   a display;
   a second position and posture sensor configured to detect a position and a posture of the display terminal;
   a second processor; and
   a second communication interface configured to transmit and receive data to and from the image capturing terminal,
the first processor of the image capturing terminal being configured to:
   in an image capturing reference state set within a real space in which the image capturing terminal is present, set the position of the image capturing terminal as an image capturing reference point and set a direction toward which a front of the image capturing terminal is directed from the image capturing reference point as an image capturing reference direction;
   transmit the image capturing reference point and the image capturing reference direction to the display terminal;
   based on sensor information from the first position and posture sensor, acquire a change in the position of the image capturing terminal relative to the image capturing reference point and a posture change quantity of the image capturing terminal relative to the image capturing reference state when the camera captures a video of an image capturing target object; and
   transmit, to the display terminal, the change in the position of the image capturing terminal and the posture change quantity of the image capturing terminal as first correction information, together with captured video information generated by capturing the video of the image capturing target object using the camera,
the second processor of the display terminal being configured to:
   in a display reference state set within a real space in which the display terminal is present, set the position of the display terminal as a display reference point and set a direction toward which a front of the display terminal is directed from the display reference point as a display reference direction;
   based on sensor information from the second position and posture sensor, acquire a change in the position of the display terminal relative to the display reference point and a posture change quantity of the display terminal relative to the display reference state as second correction information;
   correct the captured video information using the first correction information and the second correction information so as to match a positional relation of the image capturing target object based on the image capturing reference point and the image capturing reference direction with an apparent positional relation of the video of the image capturing target object based on the display reference point and the display reference direction; and
   display the captured video information thus corrected on the display.

### APPENDIX 2

A video sharing method to be executed by an image capturing terminal and a display terminal which are connected with each other for communication therebetween, the method comprising:
by the image capturing terminal, in an image capturing reference state set within a real space in which the image capturing terminal is present, setting a position of the image capturing terminal as an image capturing reference point and setting a direction toward which a front of the image capturing terminal is directed from the image capturing reference point as an image capturing reference direction;
by the image capturing terminal, acquiring a change in the position of the image capturing terminal relative to the image capturing reference point and a posture change quantity of the image capturing terminal relative to the image capturing reference state when capturing a video of an image capturing target object;
by the image capturing terminal, transmitting, to the display terminal, the change in the position of the image capturing terminal and the posture change quantity of the image capturing terminal as first correction information, together with captured video information generated by capturing the video of the image capturing target object;
by the display terminal, in a display reference state set within a real space in which the display terminal is present, setting the position of the display terminal as a display reference point and setting a direction toward which a front of the display terminal is directed from the display reference point as a display reference direction;
by the display terminal, acquiring a change in the position of the display terminal relative to the display reference point and a posture change quantity of the display terminal relative to the display reference state as second correction information; and
correcting the captured video information using the first correction information and the second correction information so as to match a positional relation of the image capturing target object based on the image capturing reference point and the image capturing reference direction with an apparent positional relation of an image capturing target object video based on the display reference point and the display reference direction, and displaying the captured video information thus corrected on a display.

### REFERENCE SIGNS LIST

1A: image capturing terminal
1B: display terminal
2A: user
2B: user
3A: access point
3B: access point
4: communication network
5A: smartphone
5B: smartphone
7: image capturing target object
8: image capturing target object video
100: video sharing system
111A: out-camera
111B: out-camera
113A: ranging sensor
113B: ranging sensor
114A: RTC
114B: RTC
115A: acceleration sensor
115B: acceleration sensor
116A: gyroscope sensor
116B: gyroscope sensor
117A: geomagnetic sensor
117B: geomagnetic sensor
118A: positioning sensor
118B: positioning sensor
119A: display
119B: display
120A: network communication I/F
120B: network communication I/F
121A: microphone
121B: microphone
122A: speaker
122B: speaker
123A: antenna
123B: antenna
125A: processor
125B: processor
126A: program
126B: program
127A: data
127B: data
128A: memory
128B: memory
135A: position and posture sensor
135B: position and posture sensor
136A: PP camera
136B: PP camera
137A: PP ranging sensor
137B: PP ranging sensor
140A: bus
140B: bus
211A: out-camera
211B: out-camera
212A: in-camera
212B: in-camera
213A: ranging sensor
213B: ranging sensor
214A: RTC
214B: RTC
215A: acceleration sensor
215B: acceleration sensor
216A: gyroscope sensor
216B: gyroscope sensor
217A: geomagnetic sensor
217B: geomagnetic sensor
218A: positioning sensor
218B: positioning sensor
219A: display
219B: display
220A: network communication I/F
220B: network communication I/F
221A: microphone
221B: microphone
222A: speaker
222B: speaker
223A: antenna
223B: antenna
225A: processor
225B: processor
226A: program
226B: program
227A: data
227B: data
228A: memory
228B: memory
230A: touch panel
230B: touch panel
231A: telephone network communication I/F
231B: telephone network communication I/F
235A: position and posture sensor
235B: position and posture sensor
236A: PP camera
236B: PP camera
237A: PP ranging sensor
237B: PP ranging sensor
240A: bus
240B: bus
301: position and posture measurement section
302: image capturing processing section
303: transmission information generation section
304: communication control section
311: communication control section
312: position and posture measurement section
313: video information storage section
314: display video generation section
315: display control section
400: image capturing reference state
410: image capturing reference point
411: image capturing terminal position
415: image capturing target object reference distance
420: image capturing reference direction
430: front direction
435: image capturing cradle angle
440: captured video
441: captured video
450: captured video center
470: target object center point
480: image capturing front point
490: captured video range
500: display reference state
510: display reference point
511: display terminal position
520: display reference direction
530: front direction
535: display cradle angle
540: display video
541: display video
542: display video
550: display video center
570: target object center point
580: display front point
590: captured video range
600: meter

1. A video sharing system comprising an image capturing terminal and a display terminal which are connected with each other for communication therebetween,
the image capturing terminal including:
a camera;
a first position and posture sensor configured to detect a position and a posture of the image capturing terminal;
a first processor; and
a first communication interface configured to transmit and receive data to and from the display terminal,
the display terminal including:
a display;
a second position and posture sensor configured to detect a position and a posture of the display terminal;
a second processor; and
a second communication interface configured to transmit and receive data to and from the image capturing terminal,
the first processor of the image capturing terminal being configured to:
in an image capturing reference state set within a real space in which the image capturing terminal is present, set the position of the image capturing terminal as an image capturing reference point and set a direction toward which a front of the image capturing terminal is directed from the image capturing reference point as an image capturing reference direction;
transmit the image capturing reference point and the image capturing reference direction to the display terminal;
based on sensor information from the first position and posture sensor, acquire a change in the position of the image capturing terminal relative to the image capturing reference point and a posture change quantity of the image capturing terminal relative to the image capturing reference state when the camera captures a video of an image capturing target object; and
transmit, to the display terminal, the change in the position of the image capturing terminal and the posture change quantity of the image capturing terminal as first correction information, together with captured video information generated by capturing the video of the image capturing target object using the camera,
the second processor of the display terminal being configured to:
in a display reference state set within a real space in which the display terminal is present, set the position of the display terminal as a display reference point and set a direction toward which a front of the display terminal is directed from the display reference point as a display reference direction;
based on sensor information from the second position and posture sensor, acquire a change in the position of the display terminal relative to the display reference point and a posture change quantity of the display terminal relative to the display reference state as second correction information;
correct the captured video information using the first correction information and the second correction information so as to match a positional relation of the image capturing target object based on the image capturing reference point and the image capturing reference direction with an apparent positional relation of the video of the image capturing target object based on the display reference point and the display reference direction; and
display the captured video information thus corrected on the display.

2. The video sharing system according to claim 1, wherein
the image capturing reference state and the display reference state are set based on a user instruction.

3. The video sharing system according to claim 1, wherein
the image capturing reference state is set based on an average position and an average posture of the image capturing terminal.

4. The video sharing system according to claim 1, further comprising a captured video storage section configured to store previously captured video information therein, wherein
the second processor is configured to:
in a case where a captured video range of the captured video information thus corrected does not cover a whole display area of the display, extrapolate a previously captured video on an area around the captured video range; and
display the captured video information thus processed.

5. The video sharing system according to claim 1, wherein
the image capturing terminal further includes a wide-angle camera,
the image capturing terminal transmits a video captured using the wide-angle camera to the display terminal, and
the second processor is configured to:
in a case where a captured video range of the captured video information thus corrected does not cover a whole display area of the display, extrapolate the video captured using the wide-angle camera on an area around the captured video range; and
display the captured video information thus processed.

6. A video sharing method to be executed by an image capturing terminal and a display terminal which are connected with each other for communication therebetween, the method comprising:
by the image capturing terminal, in an image capturing reference state set within a real space in which the image capturing terminal is present, setting a position of the image capturing terminal as an image capturing reference point and setting a direction toward which a front of the image capturing terminal is directed from the image capturing reference point as an image capturing reference direction;
by the image capturing terminal, acquiring a change in the position of the image capturing terminal relative to the image capturing reference point and a posture change quantity of the image capturing terminal relative to the image capturing reference state when capturing a video of an image capturing target object;
by the image capturing terminal, transmitting, to the display terminal, the change in the position of the image capturing terminal and the posture change quantity of the image capturing terminal as first correction information, together with captured video information generated by capturing the video of the image capturing target object;
by the display terminal, in a display reference state set within a real space in which the display terminal is present, setting the position of the display terminal as a display reference point and setting a direction toward which a front of the display terminal is directed from the display reference point as a display reference direction;
by the display terminal, acquiring a change in the position of the display terminal relative to the display reference point and a posture change quantity of the display terminal relative to the display reference state as second correction information; and
correcting the captured video information using the first correction information and the second correction information so as to match a positional relation of the image capturing target object based on the image capturing reference point and the image capturing reference direction with an apparent positional relation of an image capturing target object video based on the display reference point and the display reference direction, and displaying the captured video information thus corrected on a display.
